(19) United States
(12) Patent Application Publication
(10) Pub. No.: US 2013/0235205 A1
(43) Pub. Date: Sep. 12, 2013

(54) METHOD FOR MONITORING WOOD HARVESTING, AND A SYSTEM

(71) Applicant: Minna Lappalainen, Vaajakoski (FI)

(72) Inventor: Minna Lappalainen, Vaajakoski (FI)

(21) Appl. No.: 13/989,160

(22) PCT Filed: Nov. 22, 2011
(86) PCT No.: PCT/FI2011/051024

§ 371 Date: May 23, 2013

(30) Foreign Application Priority Data
Nov. 24, 2010 (FI) 20106239

(51) Int. Cl. G06Q 50/02

(52) U.S. Cl. CPC G06Q 50/02
USPC 348/148; 340/870.07

(57) ABSTRACT

A method and a system for monitoring wood harvesting. According to the method, image data, measuring device data and location data are generated on wood harvesting at a forest working site. The produced data is conveyed from a forest machine (1) to a server (12) where data items are combined and they are modified to a more readily understandable form. The provided monitoring data may be presented in the service user's electronic terminal device (17) logged into the server.

### BACKGROUND OF THE INVENTION

The invention relates to a method for monitoring wood harvesting.

The invention also relates to a system for wood harvesting, the system being equipped with devices for monitoring on-site wood harvesting.

The field of the invention is described in more detail in the preambles of the independent claims of the patent application.

More and more forest owners live in the cities, far from the woodland estates they own. This development will continue also in the future, when woodland estates will be inherited by new owners. In addition, the forest interests investors, because it is real and safe property with stable yield. The investors also constitute a new owner group. More and more forest owners live today, and even more so in the future, at a long distance from their forest estate, and they do not have sufficient knowledge about their own forest and how to manage it. For the state and yield of the forest it is important that the forest owner is interested in the management of his/her property and also in the sale of timber. Currently, it is difficult for a faraway forest owner to follow the implementation of a concluded wood sale, for instance, because it requires traveling to the site. Further, it is very difficult for an inexperienced forest owner, even when on site, to get a clear picture of wood harvesting and the situation. These drawbacks diminish the willingness to sell wood and the interest in forestry.

### BRIEF DESCRIPTION OF THE INVENTION

The object of the invention is to provide a novel and improved method and system by which wood harvesting may be monitored remotely.

The method of the invention is characterized by producing image information on a forest working site during harvesting and conveying image information to a server; determining a location of a forest machine at the wood harvesting site by means of a positioning device and conveying location data to the server; and interlinking measuring device data, image data and location data conveyed to the server so as to produce monitoring data illustrating the implementation of wood harvesting for the user.

The system of the invention is characterized in that a forest machine is equipped with at least one camera for taking pictures of the forest working site; that the forest machine is equipped with at least one positioning device for determining the location thereof; that a data transmission unit of the forest machine is arranged to convey image data and location data to a server; and that the server is arranged to interlink the measuring device data, image data and location data conveyed to the server so as to generate monitoring data for monitoring the implementation of wood harvesting.

The basic idea is to produce image data, measuring device data and location data at a forest working site. These data items are supplied to a server, where they may be interlinked. It is possible to establish a connection to a server from an electronic terminal device which has access to a monitoring service and which comprises a display unit for displaying the monitoring data generated on the server for one or more users logged in the service. The monitoring data is not provided for controlling the operation of the wood harvesting apparatus, but the monitoring data is provided for monitoring and illustrating the implementation of a finished or on-going wood harvesting operation. The monitoring data is thus utilized outside the forest working site.

An advantage is that it is quick and simple for the monitoring service user to log into the service on a dedicated server, where he or she can check the situation on the forest working site. Thus, the user need not travel to the site, and consequently travel costs and time are saved. Further, monitoring of wood procurement is easier than before, especially for new, inexperienced persons, because monitoring data may be presented for the user on selected, most essential matters, and data may be combined to better illustrate and concretize the matter. It is also possible to provide further information on the forest and wood procurement in a versatile and understandable manner for the user. In addition, electronic monitoring is ecological.

The basic idea of an embodiment is that on a forest working site operations are carried out by one or more manned forest machines. A manned forest machine is operated by a driver who gives control commands to the forest machine for performing the work. Monitoring data is information illustrating the execution of the forest work, without direct effect on the driver and the forest machine on site. Monitoring data is conveyed to a person outside the forest working site so as to illustrate the execution of work.

The basic idea of an embodiment is that wood procurement to be monitored is one of the following: first thinning, second thinning, final cutting, cutting of energy wood, cutting and baling of energy wood, cutting and baling of raw-material wood, baling of waste wood, stump collection. Naturally, it is also possible that one and the same user has two or more on-going wood harvesting projects on the same forest property or on different forest properties, which are monitored simultaneously.

The basic idea of an embodiment is that the user of the monitoring service is one or more of the following: forest owner, purchaser of wood, end user of wood, an agent or interest group in the field of forestry. For logging into the monitoring service, selected parties may be provided with a login key in a simple manner, and access may be limited subsequently.

The basic idea of an embodiment is that static pictures, i.e. so-called still pictures are produced on the forest working site.

The basic idea of an embodiment is that moving pictures, i.e. video image, are produced on the forest working site.

The basic idea of an embodiment is that real-time image information is displayed to the user.

The basic idea of an embodiment is that the forest machine is equipped with one or more cameras. The camera may be placed inside the cabin, whereby it may take pictures through a window. The camera may also be placed on the cabin roof, on a separate camera stand or on an operating boom.

The basic idea of an embodiment is that the triggering (still camera) or start and stop (video camera) of the camera are synchronized on the basis of work stages performed by the forest machine. In that case the camera is arranged to shoot one or more predetermined work stages of the forest machine. For the work stage to be captured on a picture it is possible to predetermine the critical stages of harvesting, the work stages that affect most the financial result, the most interesting work stages selected by the user or work stages selected on the basis of some other criteria. When the determined criterion is met, the camera activates automatically.

The basic idea of an embodiment is that image material is produced and delivered to a server automatically according to the control commands the control system of the forest machine gives to its actuators or systems. The control unit of the camera may be connected to the control unit of the forest machine, and consequently the control unit of the camera may detect the given control commands or the like signals and, on the basis thereof, may control the shooting. The control unit of the forest machine may comprise a CAN bus, to which the control unit of the camera may be connected.

The basic idea of an embodiment is that the camera's triggering or start and stop functions will take place on a timed basis. Image data may be produced, for instance, at intervals of quarter of an hour, half an hour or one hour. The images may be organized on the server in chronological order, whereby it will be easy to view the events of the working day afterwards.

The basic idea of an embodiment is to supply satellite images on a forest working site to a server. The satellite image and image material modified therefrom may be presented in the user interface of the user's terminal device.

The basic idea of an embodiment is to produce image material on a forest working site by several different cameras simultaneously. The user of the monitoring service may be given an option to select one or more image data item to be presented in the user interface.

The basic idea of an embodiment is that at the forest working site there is one or more ground cameras outside the forest machine. The camera may be arranged, for instance, to rest on a separate ground support, a tree or the like. A camera of this kind may produce a general view, for instance, in addition to that of the camera on the forest machine and the satellite picture. Further, the forest machine operator may have a portable camera at his disposal, by which pictures may be captured on special situations in harvesting, for instance.

The basic idea of an embodiment is that measuring device data produced by the forest machine is one or more of the following: weight, length, volume, moisture content, wood grade. In connection with the forest machine's cutting head, grapple, work boom, baler or the like there may be arranged one or more measuring devices for measuring the physical properties of the wood material to be handled.

The basic idea of an embodiment is that the user terminal device is one of the following: a portable computer or a tabletop computer connected to a data network, a mobile phone, a so-called smartphone of a new generation, a palmtop computer or another corresponding electronic terminal device, which allows establishment of a wired or wireless datacommunication connection to a server and the display unit of which allows presentation of information received from the server.

The basic idea of an embodiment is that the server is arranged to process the data supplied thereto from the forest working site and other data stored in advance thereon. On the server it is possible to execute a computer program which, on the basis of the server input data, may convert the monitoring data on the forest working site to a form that is more easily understandable to the user. In addition, the wood harvesting result may be illustrated in various ways in the user interface. The importance of wood harvesting may be put into more specific terms by presenting converted reference values on the data collected. The user has an option to select reference values that interest him most.

The basic idea of an embodiment is to monitor the operation of a work machine equipped with a wood material baler at a forest working site. The baler may compress and wrap to bales wood material, e.g. slash, or the work machine may be equipped with felling means, whereby it may be used for cutting and baling of thinned wood material or material collected from a small timber area.

The basic idea of an embodiment is that the work machine includes a baler that is equipped with a weighing device which allows a finished bale to be weighed before being removed from the baler. The baler may include weighing arms provided with sensors, on top of which the bale will rest after compression and binding and wherefrom the bale will be eventually dropped down. Measuring data from the weighing device is conveyed from the work machine to the monitoring system which may calculate various numerical values on the basis of the measuring data as well as convert and calculate illustrative reference data on the basis of the weighing data, such as financial yield from wood procurement, collected energy amount and various reference values thereof, as well as a reduced carbon footprint. These reference values may be calculated on a continuous basis as wood harvesting progresses.

The basic idea of an embodiment is to convey messages between the user and the operator of the forest machine through the monitoring system. Further, if a plurality of users have access to the monitoring service, messages may be conveyed between the plurality of users. The messages may be, for instance, SMS messages or other written messages, or they may be voice messages. A video conference is also possible.

The basic idea of an embodiment is to display to the user of the monitoring service a map and the picture taking location on the map simultaneously with the camera picture.

The basic idea of an embodiment is to present to the user of the monitoring service the GPS coordinates, or the like, of the picture taking locations and other selected locations. On the basis of the coordinates it will be easy for the user to visit the stored location later on.

The basic idea of an embodiment is to determine the route driven by the forest machine and store it on the server. In addition, picture material produced during the work is linked to the drive route on the server. In that case the drive route and an option to monitor the image data in various drive route locations may be presented to the user of the monitoring service.

The basic idea of an embodiment is to show the user of the monitoring service a map, an aerial picture or a satellite picture, in which the picture taking locations are indicated. When an indicated picture taking location is selected in the user interface, the display opens a picture captured in this particular picture taking location. In addition, it is possible to present measuring device data and cumulative data generated therefrom on the result of the wood harvesting. The route travelled by the forest machine may also be presented on a map and in a satellite picture. In this embodiment it is possible to combine location data, camera picture data, map data and measuring device data.

The basic idea of an embodiment is to store map material on a forest working site on a server. The maps may include a base map, a pattern map on an entire wood parcel, a detailed map on the wood pattern to be processed and a boundary map. Further, it is possible to provide and store work plans and maps showing clearing roads, wood material gathering sites and other items associated with wood harvesting.

The basic idea of an embodiment is that the server incorporates an image bank where pictures captured on a forest working site are stored for subsequent viewing. It is also possible to store in the image bank various maps, pictures taken by the user himself and other image material.

The basic idea of an embodiment is to perform one or more follow-up shootings after the harvesting. The follow-up shooting may be performed, for instance, in a few years' time after the wood harvesting, and thus feedback will be obtained on the effects of wood harvesting on the forest. The forest owner may thus compare pictures prior to harvesting, pictures immediately after harvesting and subsequent follow-up pictures, and having compared temporally different pictures, he may clearly detect the effect of harvesting on the growth or reproduction of the forest. Image information obtained at different times on the same spot may be presented in the user interface of the user terminal device as a series of pictures, or in some other illustrative manner.

The basic idea of an embodiment is that the user interface comprises a function whereby the user may forward a selected picture, combined data, a reference value or any information known to him to electronic addresses of his own choice, for instance, to email addresses or to be distributed via social media.

The basic idea of an embodiment is to generate 3D image on a forest working site. The 3-dimensional picture provides the user of the service with an even better impression on the forest working site to be monitored.

The basic idea of an embodiment is to employ the monitoring system for training and instructing the operator of a forest machine. Further, the monitoring system may be utilized for work supervision purposes, whereby a supervisor may monitor wood harvesting without visiting the working site. Yet further, the system may be utilized for settling device malfunctions, problematic situations in harvesting and the like, as well as for other communication. It may also contribute to work safety and safe storing of a forest machine on a working site.

The basic idea of an embodiment is to present in the user interface of the monitoring system information on persons, companies and machines participating in the wood harvesting. For instance, it is possible to introduce to the user the operator of the forest machine and the forest machine to be employed.

The basic idea of an embodiment is to capture on pictures one or more of the following locations or matters of interest relating to wood harvesting: wood material gathering site, skid road, road leading to parcel, general picture for verifying quality of harvesting, objects under the forest law and other agreed, special objects in the forest. With these additional pictures it is possible to convey to the user, particularly forest owner, information on interesting items, and consequently the user need not necessarily go in person to verify the situation on the wood parcel after harvesting.

### BRIEF DESCRIPTION OF FIGURES

Some embodiments of the invention are described in greater detail in the attached drawings, in which

FIG. 1 shows schematically a forest machine and generation of monitoring data on wood harvesting at a forest working site,

FIG. 2 shows schematically an alternative solution for supplying monitoring data to a server,

FIG. 3 shows schematically a user interface, in which information is presented to a user by means of a monitoring service, and

FIG. 4 is a chart of features and matters relative to the monitoring system of the invention.

In the figures, some embodiments of the invention are shown simplified for the sake of clarity. Like reference numerals refer to like parts in the figures.

### DETAILED DESCRIPTION OF SOME EMBODIMENTS OF THE INVENTION

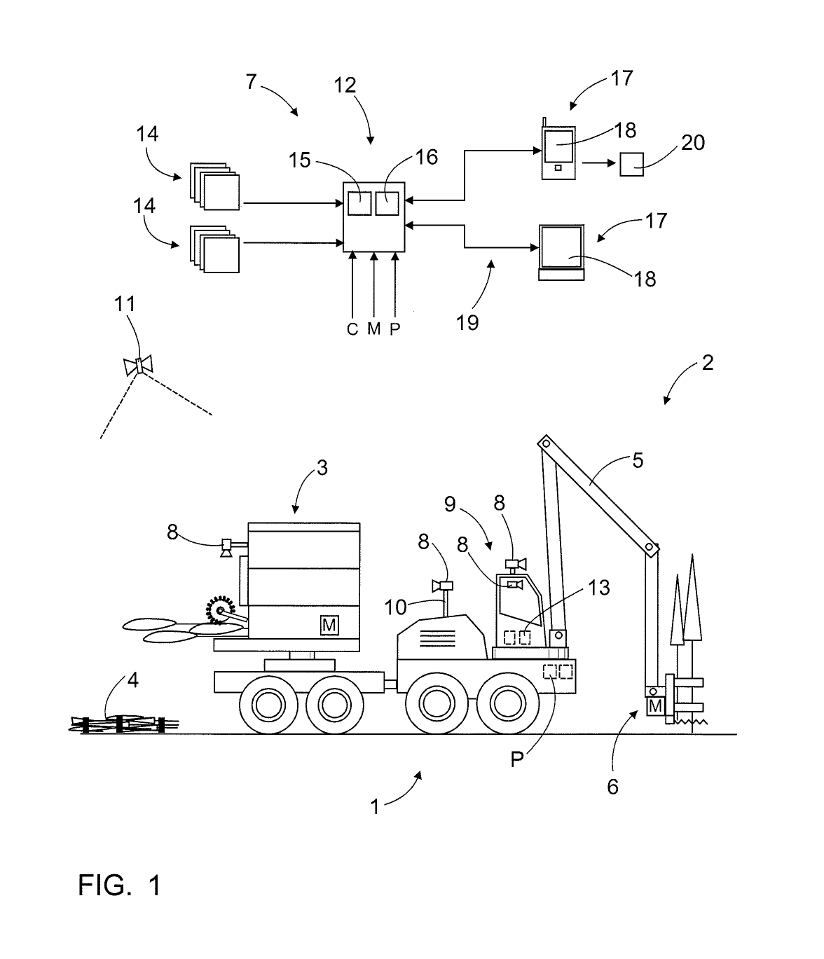

FIG. 1 shows one possible forest machine 1, by which wood harvesting may be performed at a forest working site 2. In this case, on a carrier of the forest machine 1 there is arranged a baler 3, by which wood material dispensed on a feeder may be compressed and bound to bales 4. The forest machine 1 also comprises a work boom 5 which may be equipped with a felling device 6 for grabbing and cutting trees. Alternatively, the forest machine 1 may be a multi-function machine, for instance, by which logs are felled and cut.

According to the inventive idea, at the forest working site 2 there is produced picture material that is conveyed to a monitoring system 7 of wood harvesting. The forest machine 1 may be equipped with one or more cameras 8 which may be placed such that they allow monitoring of matters that are of interest from the viewpoint of harvesting. The camera 8 may be placed, for instance, inside a cabin 9, when it is protected by the cabin. Further, the operator of the forest machine 1 may then manually turn the camera, activate the camera or otherwise intervene in the operation of the camera. The camera may also be placed on the roof of the cabin 9 or in some other way on the same rotating base with the cabin 9 and the work boom 5. Further, it is possible to arrange the camera 8 on a baler 3 or some other forest machine device, and thus pictures may be taken therewith on a selected, critical target. It may also be possible to arrange the camera 8 on a separate camera stand 10.

Modern cameras based on digital technology are small in size, high in resolution, durable and also quite affordable in price. One or more of these cameras 8 may be arranged on the forest machine 1.

The camera 8 may be arranged to turn and/or to zoom in accordance with a work step to be performed. The camera 8 may have a predetermined shooting program, in which a work cycle of the forest machine is shown in a desired manner. Further, if a plurality of cameras are employed, it is possible to determine in advance which camera will be the best to capture each particular event to be monitored on a picture. The user of the service may be given an option to create a shooting program of his own, or in the user interface there may be ready-to-use shooting programs for the user to select from. The pictures may also be arranged for being captured on a temporal basis, for instance at one-hour intervals.

The user and the operator of the forest machine may affect the direction of the camera 8 manually. The camera 8 may be arranged turnable with a turning device, which may include a pivot and a rotation motor. In the user interface the user may give commands to turn the camera. Correspondingly, the operator may control the camera from the cabin.

The forest machine 1 may carry one or more cameras 8, the operation of which is synchronized with the functions of the forest machine 1. In that case the picture taking system may be connected to the control system of the forest machine 1, whereby synchronization may take place automatically. The camera system may be connected to the CAN (Controller Area Netwok) bus of the forest machine.

In the forest machine 1 equipped with a baler 3, points of interest regarding picture shooting may include e.g. the following work steps: completion and removal of a bale 4, feeding of wood material onto the baler 3 and various steps of a felling head 6, such as grabbing, cutting and transfer of trees onto the baler 3. Correspondingly, in a harvesting machine, i.e. a multi-function harvester, interesting work steps may include felling of a tree and cutting into logs.

Image material on the forest working site 2 may also be produced by means of a satellite 11. In some cases aerial photography may also be an option. Pictures captured from above allow presentation of a wider area and location of the target to the user.

In connection with the felling device 6, the baler 3 and other devices on the forest machine 1 it is possible to arrange one or more measuring devices M by which it is possible to measure one or more physical properties of the wood material. On the baler 3 the finished bales 4 may be weighed before they are dropped down. When necessary, the volume of the bales 4 may also be measured. Further, when the forest machine 1 is a multi-function apparatus, the measuring device M in connection with the felling device 6 may measure at least the diameter and length of a tree. The forest machine 1 may also comprise means for detecting and measuring the moisture content in wood material and the wood grade.

In this context the measuring device may refer to a single sensor, by which a physical quantity may be measured, or it may refer to a unit consisting of one or more sensors and the relating mechanical or electrical auxiliary means. With the measuring device there may also be integrated a data transmission unit, by means of which measuring data may be forwarded, or alternatively, the data transmission unit is a separate unit.

For determining the location of the forest machine 1 it is equipped with a positioning device, for instance, a GPS positioner P.

The monitoring system 7 comprises at least one server 12, to which image data C, measuring device data M and location data P on a forest working site 2 will be supplied. For data transmission the forest machine 1 is equipped with one or more data transmission units 13, which may supply said data to the server 12 over a wireless data transmission path. Further, it is possible to load onto the server 12 various data elements 14, such as map templates, plans, statistics, conversion coefficients and the like. On the server 12 it is possible to execute a computer program 15, which may modify the input data and convert it to a form suitable for the user to monitor it. Further, the server 12 may comprise one or more memory units 16, in which it is possible to store monitoring data for subsequent viewing. Access to the server 12 may be allowed from one or more electronic terminal devices 17. The terminal device 17 may be a mobile phone or a computer, on the display 18 of which monitoring data may be presented. Between the server 12 and the terminal device 17 there may be a data network 19, such as the Internet, for instance. The user may have a possibility to forward the desired data to the desired electronic addresses 20.

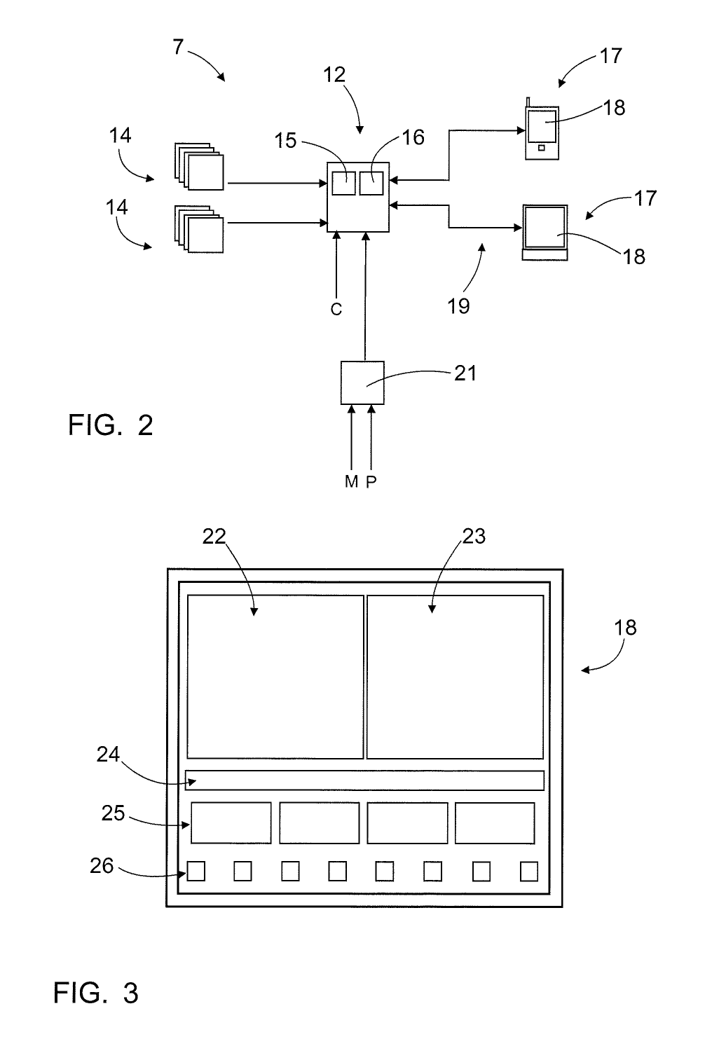

FIG. 2 shows an embodiment of the monitoring system 7, in which part of the monitoring data produced at the forest working site 2 is first supplied to an additional server 21 and therefrom to an allocated server 12 of the system 7. For instance, measuring data and location data may be supplied in this way.

FIG. 3 shows a display unit 18 of an electronic device and a possible implementation of a user interface in the system. The user interface may comprise, for instance, a first picture element 22, in which real-time image data or images from an image gallery will be displayed. The picture taking location may be shown on a map template, on a satellite image or on an aerial image in another image element 23. The user interface may also include a visual indicator 24 indicating progress in wood harvesting. The result and significance of wood harvesting may be put into specific terms and illustrated by means of reference indicators 25. Naturally, the user interface also comprises function keys 26. The appearance of the user interface may be modified in a desired manner.

About the reference figures and indicators it may be stated that the wood harvesting and its results may be illustrated and put into specific terms by modifying the data supplied to the server. The server may comprise a computer program the execution of which converts values to a predetermined form. In the user interface the user may be presented, for instance, data, calculations and reference values as follows:
the sum total of a realized wood transaction in terms of money
the amount of money produced by wood harvested at that time, earning counter
estimated total duration of harvesting and remaining duration, wood harvesting progress counter
quantity of wood harvested at that time in volume, in wood grades
quantity of harvested, renewable energy raw material
reduction in carbon dioxide emissions provided by the quantity of the harvested, renewable energy raw material
electric power, the number of houses to be heated provided by the quantity of the harvested, renewable energy raw material
the quantity of crude oil equivalent to the quantity of the harvested, renewable raw material
quantity of traffic fuel to be obtained by the harvested, renewable raw material amount and drive kilometres enabled thereby
calculation on the effect of harvesting on forest growth and the effect of said growth on the amount of binding carbon dioxide
map presentation of wood patterns to be handled
indication of completed wood patterns on a map, e.g. by colour markings
indication of a completed part and a yet to be handled part of the wood pattern under operation, e.g. by colour markings.

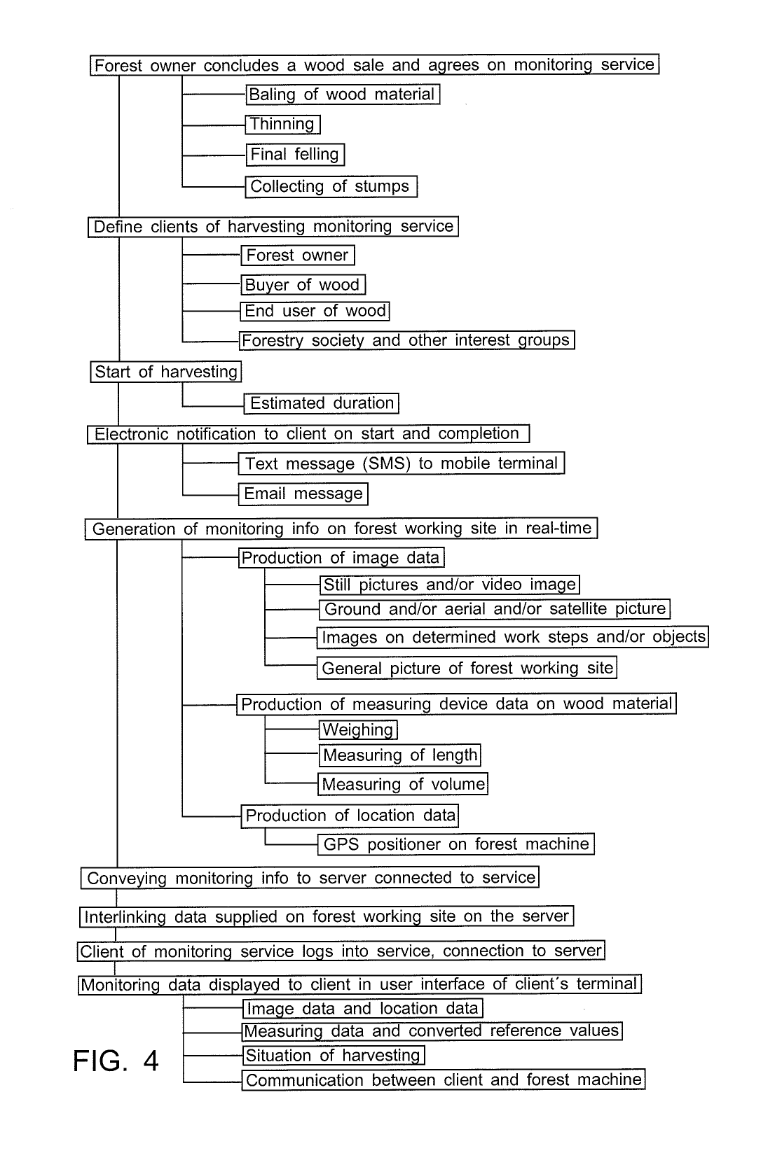

FIG. 4 shows a simplified chart of features and details of the invention and some possible embodiments thereof.

In some cases, features disclosed in this application may be used as such, irrespective of other features. On the other hand, when necessary, the features disclosed in this application may be combined to provide various combinations.

The drawings and the related description are only intended to illustrate the idea of the invention. The details of the invention may vary within the scope of the claims.

1-11. (canceled)

12. A method for monitoring wood harvesting at a forest working site, the method comprising:
measuring at least one physical property of wood material to be processed with a forest machine during harvesting and using at least one measuring device on the forest machine to obtain measuring data;
conveying the measuring data from the forest machine to at least one server;
allowing establishment of a connection between at least one user terminal device of at least one user and the at least one server for monitoring wood harvesting via a remote connection;
producing image data of the forest working site during harvesting and conveying the image data to the server;
determining the location of the forest machine at the forest working site via a positioning device and conveying location data to the server; and
interlinking the measuring data, image data and location data conveyed to the server so as to produce monitoring data illustrating the implementation of the wood harvesting.

13. The method of claim 12, comprising
conveying produced information from the forest machine to the server via a wireless data transmission connection;
establishing a connection from the server to at least one data network;
and allowing a user terminal to log into said server through the data network.

14. The method of claim 12, comprising
performing at least one conversion of the measuring data supplied to the server to act as concrete reference data;
and presenting the reference data in the user terminal device for illustrating the result of wood harvesting.

15. The method of claim 12, comprising
linking the image data and the location data to form an element and showing this element on a map, in one of an aerial picture and a satellite picture.

16. The method of claim 12, comprising
presenting an estimated total time duration of the wood harvesting via a user interface of the user terminal;
and presenting a degree of progress in wood harvesting at each particular moment in relation to the estimated total duration.

17. The method of claim 12, comprising
conveying messages via the server between the user terminal device and a terminal device on the forest machine.

18. A system for wood harvesting, the system comprising:
at least one forest machine for handling wood material at a forest working site;
at least one measuring device, which is arranged on the forest machine and which is arranged to obtain measuring data by measuring at least one physical property of the wood material to be handled during harvesting;
at least one data transmission unit, which is arranged on the forest machine;
at least one server, to which the data transmission unit is arranged to convey monitoring data regarding the forest working site;
at least one terminal device, wherefrom a connection may be established to said server and which terminal device comprises at least one display unit for presenting monitoring data to a user;
and wherein the forest machine is equipped with at least one camera for capturing image data including one or more pictures of the forest working site;
the forest machine being further equipped with at least one positioning device for determining location data describing a current location of the forest machine;
the data transmission unit of the forest machine is arranged to convey the image data and the location data to the server; and
the server is arranged to combine the measuring data, image data and location data conveyed to the server so as to provide monitoring data for monitoring the implementation of the wood harvesting.

19. The system of claim 18, wherein
a work cycle of the forest machine comprises a plurality of work steps;
at least one work step is predetermined to constitute a work step critical to monitoring; and
the critical work step is arranged to automatically control the operation of the camera.

20. The system of claim 18, wherein
the forest machine comprises at least one control unit which is arranged to give control commands to systems of the forest machine and to control a work cycle;
the camera comprises at least one control unit of its own for controlling the operation of the camera; and
the camera control unit is arranged to survey the control commands provided by the control unit of the forest machine and to synchronize activation of the camera on the basis of the identified control commands.

21. The system of claim 18, wherein
the camera may be switched on and off through manual control of the user or the forest machine operator.

22. The system of claim 18, wherein
in connection with the camera there is a turning device by which the camera is turnable by remote control; and
the camera is arranged to turn in response to a command the user has given through his terminal device.
